(19) United States
(12) Patent Application Publication
(10) Pub. No.: US 2025/0027589 A1
(43) Pub. Date: Jan. 23, 2025

(54) PIPE CONNECTORS

(71) Applicant: Acorn Intellectual Properties Limited, St. Helier (JE)

(72) Inventors: Alexander Wood, St. Lawrence (GB); Neil Keddie, Aberdeen (GB)

(21) Appl. No.: 18/684,772

(22) PCT Filed: Aug. 11, 2022
(86) PCT No.: PCT/GB2022/052103

§ 371 Date: Feb. 19, 2024

(30) Foreign Application Priority Data
Aug. 17, 2021 (GB) 2111790.8

(51) Int. Cl. F16L 37/14; F16L 21/02

(52) U.S. Cl. CPC F16L 37/148; F16L 21/022

(57) ABSTRACT

A pipe connector (10) formed as a sleeve (50) adapted to side axially over the ends of adjacent pipes (20, 30) that are to be connected to one another. The sleeve (50) and pipe ends (20, 30) have complementary internal (60, 62) and external (64, 64) grooves, respectively, that align to form channels for each receiving an elongate connector (56, 58) that mechanically connects each pipe end (20, 30) to the sleeve (50). The sleeve also has pockets (52, 54) for receiving pressure seals (28, 38) that form a seal between the sleeve (50) and each pipe end (20, 30). The pipe connector (10) is characterised by an asymmetric arrangement of the connector grooves (60, 62, 64, 66), thus permitting the axial sliding of the sleeve (50) relative to the pipe ends (20, 30) in one direction without disrupting the seals (28, 38) or catching seals on the edges of the grooves.

This invention relates to pipe connectors, and in particular, but without limitation, to pipe connectors suitable for use in oil and gas plant, production platforms, and the like.

When it is desired to join two lengths of pipe together, it is often necessary or desirable to use a pipe connector. Pipe connectors sealingly connect the ends of adjacent pipe lengths to one another, such that their bores communicate forming a continuous conduit. Pipe connectors are sometimes preferred over, for example, bolted, glued or welded pipe joints, due to the fact that they can be easily removed and replaced.

In order to form a pressure seal between the two lengths of pipe, a tube or sleeve is slid into position such that it overlaps both pipe ends, and the outer surfaces of these pipe ends contact and compress against the inner diameters of annular sealing devices retained within the sleeve. These annular sealing devices, hereinafter referred to as pressure seals, may be O-rings, casing seals, other types of elastomeric seal, or soft metal seals.

The sleeve usually has internal pockets for retaining the outer diameter of the pressure seals. By compressing the annular seals between the pipe and the outer surface of the pockets, a pressure seal may be formed.

Additional seals may be provided to improve the pressure sealing arrangement, such as further annular seals, or an axial seal, which is a compressible ring placed between the end faces of the abutting pipe end walls. By axially compressing the pipe ends towards one another, the between-pipe seal can be compressed against the pipe end walls and against the inner surface of the sleeve, thereby further improving the seal.

Fixing the sleeve in position can be accomplished in a number of ways, but one way is to provide retaining device grooves in each pipe end that are axially aligned with a respective retaining device groove on the inner wall of the sleeve. When correctly aligned, it is possible to insert a retaining device, such a length of wire or a flexible metal rod, into the annular cavity formed by the aligned retaining device grooves, thereby preventing or inhibiting relative axial movement of the pipe ends and/or sleeve.

The pressure seals used in pipe joints are precision seals, that are designed to withstand certain pressure, temperature, and mechanical design parameters. In order that the pressure seals' operation is not adversely affected by the environment (bearing in mind that pipes are often used in sub-sea and harsh environments), environmental seals can also be provided. Environmental seals are designed to isolate the internals of connector sleeve (and in particular the retaining devices for this sleeve) from the outside environment, thereby protecting them from water/dirt exposure and the like, and mitigating the threat of corrosion. For convenience, the environmental seals are often similarly installed to the pressure seals, namely by providing a secondary pocket, or an end recess, in the sleeve in which sits a respective environmental seal, which environmental seals also resiliently engage with the pipe end. By placing the environmental seals on the opposite sides of the pressure seals to the pipe ends being joined, this arrangement can adequately protect the pressure seals and/or the retaining devices from the environment.

Installation of a sleeve pipe connector usually involves: —preparing the pipe ends with grooves for retaining devices; fitting pressure seals inside their pockets of the sleeve; sliding the sleeve onto one pipe end; aligning the pipe ends; sliding the sleeve so that it overlies both pipe ends; fixing the sleeve in position using the retaining devices; and fitting environmental seals.

It will be appreciated that the aforedescribed arrangement(s) involve the use of a sleeve, which is axially slid over the pipe ends to be joined. However, as the sleeve comprises pressure seals that are restrained within pockets, by sliding the sleeve relative to the pipe ends, the pressure seals, which move in unison with the sleeve (and in particular, an edge of a pressure seal) can catch in one or more of the grooves in the pipe end(s) causing it/them to be pinched, cut, nicked, damaged or even become unseated, thereby defeating the seal.

The aforesaid problems pose a real problem, especially in mission-critical applications, (such as in the oil and gas industry), where failure of a pipe joint may have catastrophic consequences. A need therefore exists for: a solution to one or more of the above problems; and/or a solution to one or more shortcomings associated with known pipe connectors; and/or for an improved and/or alternative type of pipe connector. This invention aims to provide a solution.

Aspects of the invention are set forth in the appended independent claim or claims. Preferred and/or optional features of the invention are set forth in the appended dependent claims.

According to one aspect of the invention, there is provided a pipe connector comprising: a sleeve which is: moveable between: an installed position in which it surrounds and overlaps the ends of a first and a second pipe; and a retracted position in which it surrounds and overlaps just one of the ends of the first and second pipes; and which has: first and second retaining device grooves formed on its inner surface that axially align, when in the installed position, with respective complementary retaining device grooves formed on an outer surface of each of the first pipe end and the second pipe end; first and second pressure seal pockets located between the first and second retaining device grooves for receiving seals that form respective pressure seals between the interior of the sleeve and the exterior of the first and second pipe ends when the sleeve is in the installed position the pipe connector additionally comprising elongate retaining devices slideably insertable into channels formed when the retaining device grooves of the sleeve and the retaining device grooves of the pipe ends are aligned, the pipe connector being characterised by: an axial distance between the free end of the first pipe end and the retaining device groove of the first pipe end being different to an axial distance between the free end of the second pipe end and the retaining device groove of the second pipe end.

It will be appreciated from the foregoing; the pipe connector of the invention provides an asymmetric arrangement whereby the retaining device on one side of the pipe joint is located closer to the pipe joint (the location where the pipe ends meet) than the retaining device located on the opposite side of the pipe joint.

Suitably, the first and second pipe ends have a region of reduced external diameter extending from their free ends to the axial position of the respective retaining device grooves.

Suitably, the axial distance difference and the regions of reduced external diameter permit the sleeve to be axially displaced between its installed position and its retracted position, and vice versa, whilst permitting a seal located within a pressure seal pocket to clear the retaining device groove during such displacement.

This asymmetric arrangement means that the sleeve can be moved to an axial position whereby the pressure seals are located to one side of the pipe joint whilst ensuring the pressure seals clear and/or do not come into contact with any retaining device grooves.

Suitably, the sleeve further comprises first, and second recesses located axially outwardly of the pressure seal pockets, the recesses receiving seals that form respective environmental seals between the interior of the sleeve and the exterior of the first and second pipe ends when the sleeve is in the installed position.

The recesses are suitably located axially outwardly of the retaining device grooves.

The environmental seals, where provided, are suitably located both axially outwardly of the pressure seals and the retaining device grooves.

In order to facilitate sliding of the sleeve, the pipe ends are suitably chamfered or fileted so as to facilitate sliding of the pressure seals over the pipe ends.

The pressure seals suitably comprise O-ring seals or casing seals depending on the application requirements and/or the diameter of the pipe. In certain embodiments, the pressure seals can be soft metal pressure seals to allow higher temperature service operating conditions for the coupling. The environmental seals suitably comprise O-ring or elastomeric seals.

The or each retaining device comprises an elongate, flexible member, which seats in the retaining device grooves so as to form a mechanical connection between the pipe ends and the sleeve.

The or each retaining device suitably comprises any one or more of the group comprising: a flexible elongate metal rod; a spring; a length of multi-stranded metal wire; a push-chain; and a flexible wire comprising spaced-apart ferrules or beads. An external profile of the flexible elongate metal rod; the spring; the length of multi-stranded metal wire; the push-chain; and the ferrules or beads preferably corresponds to an internal profile of the channel formed by the aligned retaining device grooves of the sleeve and the pipe ends.

The sleeve suitably comprises a through aperture or lead-in channel leading into the retaining device grooves, through which aperture, in use, the retaining device(s) can be inserted or retracted.

The through aperture or lead-in channel, is essentially a passageway in communication with the retaining device grooves through which the retaining device can be inserted or retracted so as to form a mechanical connection between the pipe ends and the sleeve or to disconnect the sleeve from the pipe ends, respectively.

The through aperture may comprises a formation, such as a screw thread, a bayonet connector, or a barb, that engages a free end of the retaining device, or a corresponding feature thereof, for the purposes of locking and/or retaining the retaining device in-situ within the channel.

An embodiment of the invention shall now be described, by way of example only, with reference to the accompanying drawings in which:

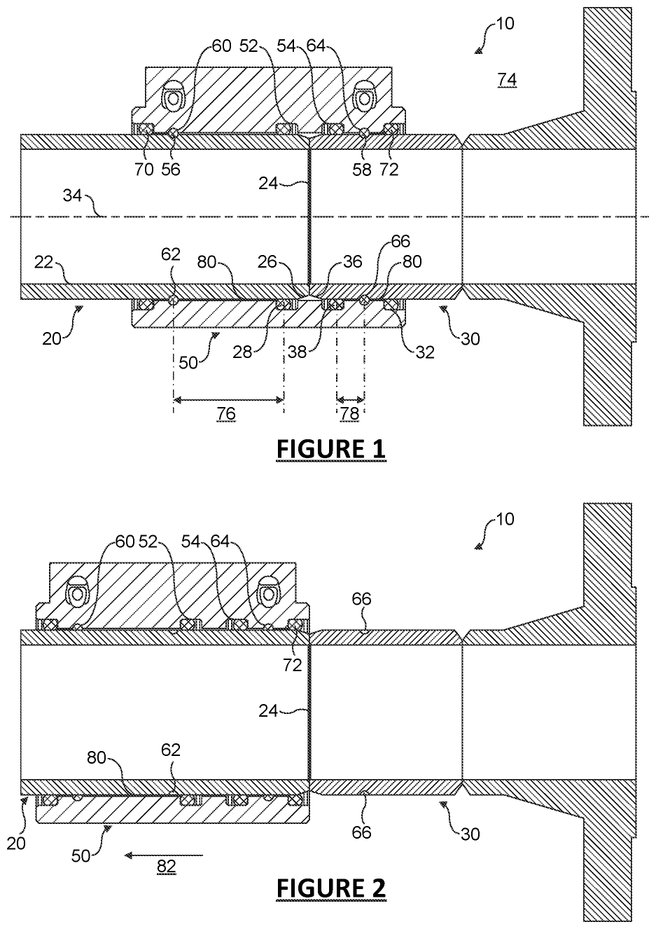

FIG. 1 is a longitudinal, sectional view of a pipe connector in accordance with the invention in a connected position;

FIG. 2 is a longitudinal section of the pipe connector of FIG. 1 with the sleeve in a retracted/disconnected position;

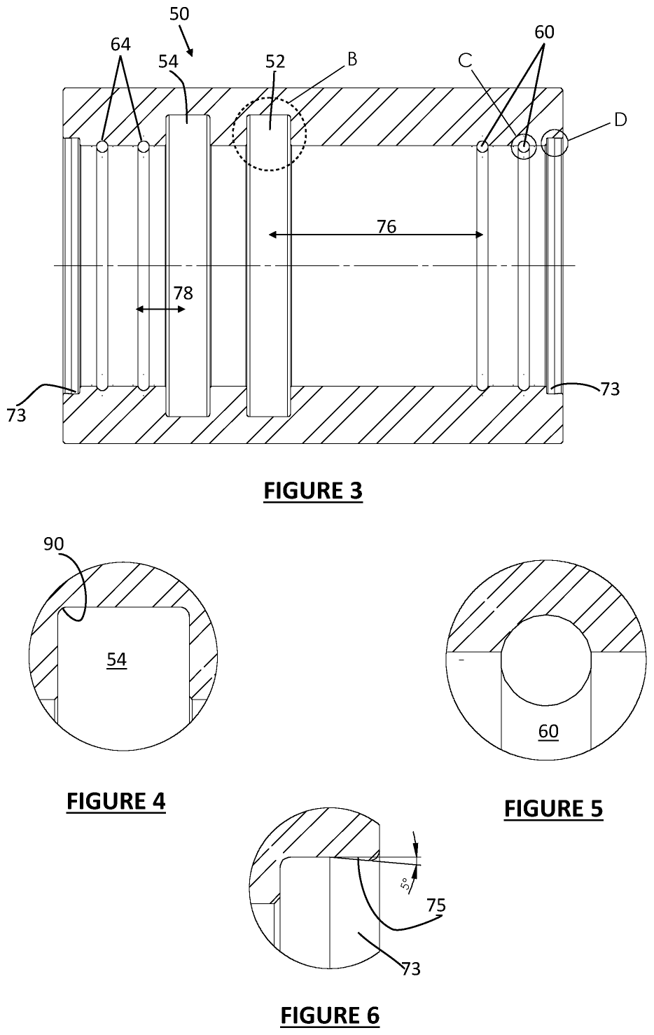

FIG. 3 is a longitudinal section of the sleeve of FIGS. 1 and 2;

FIGS. 4, 5 and 6 are detailed views of FIG. 3, respectively;

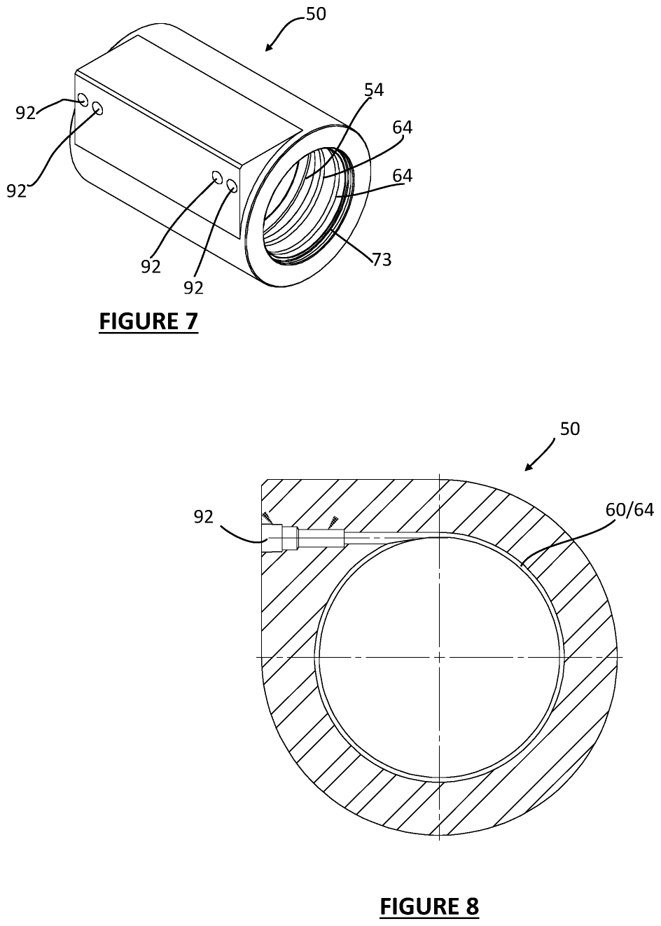

FIG. 7 is an isometric view of the sleeve shown in FIGS. 1, 2 and 3; and

FIG. 8 is a cross-sectional view of the sleeve of FIG. 7.

Referring to FIG. 1 of the drawings, a pipe connector 10 in accordance with the invention is used to connect the ends of a first pipe 20 and a second pipe 30 together. The pipes 20, 30 have an equal and constant inner diameter 22, 32 and are cut-or machined-off square so as to form a close abutting contact along a plane 24 where they meet, which plane 24 is orthogonal to a longitudinal axis 34 of the pipes 20, 30. Each pipe 20, 30 has a pipe end, which has a chamfered outer edge 26, 36 and this facilitates the sliding of a connector sleeve 50 over the pipes 20, 30. A seal is formed between the pipes 20, 30 by virtue of the sleeve 50 acting in conjunction with a pair of pressure seals 28, 38, which are axially displaced slightly from the intersection plane 24, and which are compressed by the sleeve 50 against a machined outer surface of the pipe ends so as to form a pressure seal.

The first pressure seal 28 seats in a first pressure seal pocket 52 of the sleeve; whereas the second pressure seal 38 seats in a second pressure seal pocket 54 of the sleeve. The location of the pressure seals 28, 38 is thereby determined by the locations of the pressure seal pockets 52, 54 formed on an interior surface of the sleeve 50. As can be seen in FIG. 1 of the drawings, when the pipe connector 10 is assembled, the intersection plane 24 of the pipe ends 20, 30 is located substantially midway between the first pressure seal pocket 52 and the second pressure seal pocket 54 of the sleeve 50.

In order to secure the sleeve 50 in position, a pair (or several pairs) of elongate retaining devices 56, 58 are used, which are inserted into a channel formed by axially aligned grooves in the sleeve 50 and the pipe ends 20, 30. The first retaining device 56 is part-located in a first retaining device groove 60 of the sleeve, and part-located in a complementary retaining device groove 62 formed in the outer wall of the first pipe 20. Similarly, the second retaining device 58 is part-located in a second retaining device groove 64 formed in the inner surface of the sleeve 50 and part-located in a complementary, axially aligned retaining device groove 66 formed in the outer surface of the second pipe end 30. By inserting the retaining devices 56, 58 thus, a mechanical connection is formed between the first pipe 20 and the sleeve 50; and between the second pipe 30 and the sleeve 50—thereby ensuring a fixed relationship between the first pipe 20 and the second pipe 30.

In order to prevent dirt, water, dust, contamination, and other unwanted matter from interfering with the correct operation of the pressure seals 52, 54 and the retaining devices 56, 58, environmental seals 70, 72 are also provided. These environmental seals 70, 72 are located axially outwardly of the retaining devices 56, 58 thereby ensuring that the outside environment 74 does not come into contact with the retaining devices 56, 58 or the pressure seals 52, 54.

As can be seen by inspection of FIG. 1, the distance 76 between the first retaining device 62 and the first pressure seal 28 is greater than the distance 78 between the second retaining device 58 and the second pressure seal. This creates an asymmetric arrangement around the mid plane 24 as can clearly be seen in FIG. 1. The invention is further characterised by a region 80 of reduced external diameter of the pipe ends 20, 30, formed by machining, which extends between the mid plane 24 and the locations of the retaining device grooves 62, 66 formed in the pipe ends 20, 30. The machined surface 80 also forms a suitable landing for the interior surfaces of the pressure seals.

Referring now to FIG. 2 of the drawings, when it is desired to inspect, change, repair or otherwise install or disassemble the pipe connector 10, the retaining devices 56, 58 are withdrawn thereby mechanically disconnecting the pipes 20, 30 from the sleeve 50. However, the sleeve 50 is partially retained by friction between the seals 52, 54, 70, 72 and the pipes 20, 30. Nevertheless, with the retaining devices 56, 58 removed, it is possible to axially retract 82 the sleeve as shown in FIG. 2 such that the sleeve 50 is moved to a position where it clears the mid plane 24 of the pipe joint. It will be noted, by regarding FIG. 2 in particular, that by virtue of its asymmetry the sleeve can be moved throughout the entire extent of movement 82 during the retraction process without contact between the pressure seals and the retaining device grooves formed in the pipe ends 62,66.

It will be appreciated that the second environmental seal 72 does traverse the second retaining device groove 66 formed in the outer surface of the second pipe 30, but as this is only an environmental seal 72, it is easily replaced. In any event, this environmental seal can be removed from its recess before the pipe end is axially retracted.

Once the pipe fitting has been attended to, the pipe connector 10 can be re-assembled by sliding the sleeve 50 in an opposite direction to that shown by arrow 82, aligning the retaining device grooves 64, 66, 60, 62 and re-inserting the retaining devices 56, 58.

Referring now to FIGS. 3, 4, 5 and 6, the sleeve 50 is shown in lateral section and has pressure seal pockets 52, 54 formed on its inner surface. The pressure seal pockets, 52, 54 have radiused corners 90 and this accommodates homogeneous expansion/contraction of the pressure seals 28, 38 in use, but principally reduces stresses at these positions in the pockets (which can be the weakest points of the sleeve).

The retaining device grooves 60, 64 (in this example there are two each) are formed axially outwardly of the pressure seal pockets 52, 54 and it can be seen that the separation 76 between the first pressure seal pocket 52 and the first retaining device groove 60 is greater than the distance 78 between the second pressure seal pocket 54 and the second retaining device groove 64.

End recesses 73 are also provided for receiving the environmental seals 70, 72 previously described. As can be seen from FIG. 6, the end recesses 73 are slightly undercut and this (5 degree) undercutting serves to retain the environmental seals 70, 72, which are axially inserted into the ends of the sleeve 50 and are retained there by the undercut 75.

FIGS. 7 and 8 show the sleeve 50 of FIGS. 3, 4, 5, 6 in isometric and cross-sectional view, respectively. It can be seen from these drawings, in particular, that the sleeve 50 has four lead-ins 92 which communicate with four retaining device grooves 60, 64 formed on an inner surface of the sleeve 50. An elongate, flexible retaining device (not shown in FIGS. 7 and 8) can be inserted through each of the lead-ins 92 to feed into the channels 60, 64 and wrap around the pipes 20, 30 so as to form a mechanical connection between the pipes 20, 30 and the sleeve 50.

1. A pipe connector (10) comprising:
a sleeve (50) which is:
moveable between: an installed position in which it surrounds and overlaps the ends of a first (20) and a second pipe (30); and a retracted position in which it surrounds and overlaps just one of the ends of the first (20) and second pipes (30); and which has;
first (60) and second (64) retaining device grooves formed on its inner surface that axially align, when in the installed position, with respective complementary retaining device grooves (62, 66) formed on an outer surface of each of the first pipe end (20) and the second pipe end (30);
first (52) and second (54) pressure seal pockets located between the first (60) and second (64) retaining device grooves for receiving seals (28, 38) that form respective pressure seals between the interior of the sleeve (50) and the exterior of
the first (20) and second (30) pipe ends when the sleeve (50) is in the installed position,
the pipe connector (10) additionally comprising:
elongate retaining devices (56, 58) slideably insertable into channels formed when the retaining device grooves (60, 64) of the sleeve and the retaining device grooves (62, 66) of the pipe ends (20, 30) are aligned, the pipe connector (10) being characterised by:
the distance (76) between the first retaining device groove (62) and the first pressure seal (28) is greater than the distance (78) between the second retaining device (58) and the second pressure seal (38), which creates an asymmetric arrangement, such that;
an axial distance between the free end of the first pipe end (20) and the retaining device groove (60) of the first pipe end being different to an axial distance between the free end of the second pipe end (30) and the retaining device groove (64) of the second pipe end.

2. The pipe connector (10) of claim 1, wherein the first (20) and second (30) pipe ends have a region (80) of reduced external diameter extending from their free ends to the axial position of the respective retaining device grooves (60, 64).

3. The pipe connector (10) of claim 2, wherein the axial distance difference (76, 78) and the region (80) of reduced external diameter permit the sleeve (50) to be axially displaced between its installed position and its retracted position, and vice-versa, whilst permitting a pressure seal (28, 38) located within a pressure seal pocket (52.

54. to clear the retaining device groove (60, 64) during such displacement.

4. The pipe connector (10) of claim 1, wherein the sleeve (50) further comprises first and second recesses (32) located axially outwardly of the pressure seal pockets (52, 54), the recesses (32) receiving seals (72) that form respective environmental seals between the interior of the sleeve (50) and the exterior of the first (20) and second (30) pipe ends when the sleeve (50) is in the installed position.

5. The pipe connector (10) of claim 4, wherein the recesses (32) are located axially outwardly of the retaining device grooves (60, 64).

6. The pipe connector (10) of claim 1, wherein the pressure seals (28, 38) comprise any one or more of: elastomeric seals; soft metal seals; O-ring seals; and casing seals.

7. The pipe connector (10) of claim 4, wherein the environmental seals (72) comprise O-ring seals.

8. The pipe connector (10) of claim 1, wherein the retaining devices (56, 58) comprises any one or more of the group comprising: a flexible elongate metal rod; a spring; a length of multi-stranded metal wire; a push-chain; and a flexible wire comprising spaced-apart ferrules or beads.

9. The pipe connector (10) of claim 8, wherein an external profile of the flexible elongate metal rod; the spring; the length of multi-stranded metal wire; the push-chain; and the ferrules or beads corresponds to an internal profile of the channel formed by the aligned retaining device grooves of the sleeve and the pipe ends.

10. The pipe connector (10) of claim 1, wherein the sleeve (50) comprises a through aperture or lead-in channel (92) leading into the retaining device grooves (60, 64), through which aperture, in use, the retaining devices (56, 58) can be inserted or retracted.

11. The pipe connector (10) of claim 10, wherein the through aperture (92) comprises a formation that engages a free end of the retaining device (56, 58) for retaining it in-situ within the channel.
